(19) United States
(12) Patent Application Publication
(10) Pub. No.: US 2013/0099472 A1
(43) Pub. Date: Apr. 25, 2013

(54) BOOK WITH AN ELASTIC STRAP BAND

(71) Applicant: Alexander Quehl, Worms (DE)

(72) Inventor: Alexander Quehl, Worms (DE)

(73) Assignee: LANYBOOK GMBH, Worms (DE)

(21) Appl. No.: 13/521,477

(22) PCT Filed: Jan. 12, 2011
(86) PCT No.: PCT/EP2011/000100

§ 371 Date: Jul. 11, 2012

(30) Foreign Application Priority Data
Jan. 12, 2010 (EP) 10150590.7

(51) Int. Cl. B42D 3/00

(52) U.S. Cl. CPC B42D 3/00
USPC 281/29

(57) ABSTRACT

The present invention relates to a stationary object, in particular a notebook, a writing pad, a diary, a calendar or the like, comprising a first cover, a second cover, at least one page, and an elastic strap band, which is attachable to the second cover of the stationary object, wherein the elastic strap band is configured to be wrapped around the first cover of the stationary object for keeping the covers closed. The elastic strap band is attached to the second cover with a clip.

### TECHNICAL FIELD

The present invention relates to a stationary object, in particular a notebook, a writing pad, a diary, a calendar or the like, comprising a first cover, a second cover, at least one page, and an elastic strap band, which is attachable to the second cover of the stationary object, wherein the elastic strap band is configured to be wrapped around the first cover of the stationary object for keeping the covers closed.

### BACKGROUND

From the prior art, there are known notebooks having a top cover and a bottom cover, wherein a thin strap band is provided for being wrapped around the top cover and the bottom cover of the notebook for keeping the notebook closed. The strap band is attached to the back cover and can be stretched manually for wrapping the strap band around the front cover so as to fix the front cover for keeping the book closed. By stretching the strap band again and pulling the strap band off the front cover, the front cover can be released from the elastic fixation so that the book can be opened.

### SUMMARY

The present invention is directed to the attachment of an elastic strap band on a cover of a stationary object such as a book, a notebook, a writing pad, a diary, a calendar or the like. The broad elastic strap band can be bonded, sewed, or cramped to a clip or clasp and can comprise a logo or text. The elastic strap band is then attached to a cover of a book by the clip or a clasp, for example by clipping the clip to a slot in the cover or by pulling the elastic strap band through a slot in the cover and connecting it to a clasp. The stationary object can be closed by expanding the elastic strap band and pulling it around the stationary object. The expansion force acting on the clip or clasp holds the stationary object closed and the clip or clasp in place. When the book is closed the clips can hardly be recognized and the presented attachment technique allows for quickly attaching, removing or exchanging elastic strap bands with possibly different colors, logos or texts on stationary objects.

According to the present invention, it is proposed a stationary object according to independent claims 1 and 14 and a method for attaching an elastic strap band to a cover according to independent claim 15. Preferred embodiments and features are described by the features of the dependent claims.

The stationary object comprises a first cover, a second cover, at least one page, and an elastic strap band, which is attachable to the second cover of the object, wherein the elastic strap band is configured to be wrapped around the first cover for keeping the covers closed. The elastic strap band is stretched at a predetermined stretching factor, when it is wrapped around the first cover for keeping the covers closed. The elastic strap band is configured to be further stretched for releasing the first cover. The elastic strap band is attached to a clip. The second cover comprises a slot. The elastic strap band is attachable to the first cover by the clip.

This provides the advantage that the elastic strap band can be produced independently from the stationary object. Such an independent production allows to produce a stock of stationary objects at low cost and to produce customized elastic strap bands which may comprise a printed picture such as a logo or an advertisement or a movable member on demand. The elastic strap band can then either be clipped to the stationary object by the seller of a stationary object/elastic strap band or by the buyer the book/elastic strap band depending on convenience. Furthermore, this has the advantage that the elastic strap band can be easily removed or exchanged when broken or out-dated.

The stationary object may be a book or a writing pad. The first cover may be a front cover of the book or writing pad and the second cover may be a back cover of the book or writing pad.

According to an aspect the clip may be attached to the second cover by pulling the clip through the slot.

This is advantageous as it provides for a simple way to attach the elastic strap band to the second cover without the need for special equipment.

The clip may comprise at least one elongated opening. The clip may be attached to the elastic strap band by pulling an end of the elastic strap band through the at least one elongated opening of the clip and attaching the end to the elastic strap band, the respective side of the elastic strap band thereby forming a loop.

This aspect is advantageous as it allows for a simple way to attach the elastic strap band to the clip.

According to an aspect, the slot may be rectangular and may comprise two opposing notches which also may be rectangular.

Such a form of the slot is advantageous as it allows for pulling a clip through the notches of the slot while the size of the slot prevents the clip to be pulled back without guiding the clip through the notches.

According to an aspect the clip may be a rectangular clip with a bar shaped lug on one side which extends from the clip plane in perpendicular direction. The elastic strap band may be attached to the clip by closing a loop of the elastic strap band around said lug.

Said lug is advantageous as it prevents the clip to be moved out of place when the lug extends into the slot.

According to an aspect, the clip may be a crescent-shaped clip with an elongated opening. To connect the crescent-shaped clip to the elastic strap band, a loop of the elastic strap band may be closed around the bar between the elongated opening and a concave side of the crescent-shaped clip. Alternatively, the clip may be a round or rectangular clip with two elongated openings. The round or rectangular clip may be attached to the elastic strap band by closing a loop of the elastic strap around the bar between the elongated openings of the round or rectangular clip.

A crescent-shaped clip where the bar between the elongated opening and an edge of the crescent-shaped clip near the center of the convex hull of the crescent-shaped clip is advantageous as a force acting on the bar by pulling the elastic strap band prevents the clip from moving out of a position parallel to the plane of the cover which prevents that the clip is pulled back through the slot. The same is true for a round or rectangular shape of the clip where the bar between the elongated openings is well inside the contour of the clip.

According to an aspect, the clip may comprise an elongated opening and may be attached to the elastic strap band by closing a loop of the elastic strap band around a bar between the elongated opening and an edge of the clip. A clamp may be provided which is connectable to the clip so that the connection of clip and clamp cannot be pulled back through the slot.

Such a clip clamp combination is advantageous as the slot may have a simple rectangular shape and the pulling back of the clip is rendered impossible as long as the clamp is connected to the clip.

According to an aspect, the clip may have the shape of a shuttle-armature-shaped clasp. The clasp may be attached to the elastic strap band by closing a loop of the elastic strap band around the central bar of said clasp.

Such a clasp is advantageous as the elastic strap band does not have to be pulled through an elongated opening and attached to the elastic strap band thereby forming a loop but can be manufactured independently from the clasp as the elastic strap band can be connected to the clasp by stretching a loop of the elastic strap band, pulling the first half of the clasp through the stretched loop and releasing the loop.

According to an aspect, the stationary object is a hard-bound book, an adhesive-bound book, a comb-bound book or a ring-bound book.

According to an aspect, the stationary object is a notebook, a calendar, a Filofax or a writing pad.

According to an aspect, the clip is glued to the second cover.

By gluing the clip to the cover the connection between the clip and the cover can be further fortified.

According to the present invention, the stationary object is characterized in that at least one of the covers comprises a mirror.

According to the present invention, the method comprises the steps of connecting a clip to the elastic strap band, providing a slot in a cover, and pulling the clip through the slot of the cover.

Preferably, the stationary object may comprise any combination of the above-described features of the various aspects of the present invention.

### BRIEF DESCRIPTION OF THE DRAWINGS

FIG. 1 shows a ring-bound book with an elastic strap band according to an embodiment of the present invention.

FIG. 2 shows a writing case with an elastic strap band according to an embodiment of the present invention.

FIG. 3 shows perspective views of two slots on the back of a book according to an embodiment of the present invention.

FIG. 4A shows perspective views of an elastic strap band with a rectangular clip on each end to be clipped to the back of a book according to an embodiment of the present invention.

FIG. 4B shows perspective views of an elastic strap band with a rectangular clip on each end to be clipped to the back of a book according to an embodiment of the present invention.

FIG. 5 shows perspective views of an elastic strap band with a crescent-shaped clip on each end to be clipped to the back of a book according to an embodiment of the present invention.

FIG. 6 shows perspective views of an elastic strap band with a round clip on each end to be clipped to the back of a book according to an embodiment of the present invention.

FIG. 7 shows perspective views of an elastic strap band with a rectangular clip on each end to be clipped to the back of a book using a clip shutter according to an embodiment of the present invention.

FIG. 8 shows perspective views of an elastic strap band with a rectangular clasp on each end to clip the elastic strap band to the back of a book according to an embodiment of the present invention.

FIG. 9 shows perspective views of a clasp according to an embodiment of the present invention.

FIG. 10 shows perspective views of a clasp according to an embodiment of the present invention.

FIG. 11 shows perspective views of a clasp according to an embodiment of the present invention.

FIG. 12 shows perspective views of a clip according to an embodiment of the present invention.

FIG. 13 shows perspective views of a clip according to an embodiment of the present invention.

FIG. 14 shows perspective views of an elastic strap band with a rectangular clip with a pin on each end to be clipped to the back of a book.

FIG. 15 shows perspective views of a clip according to an embodiment of the present invention.

FIG. 16 shows perspective views of a clip according to an embodiment of the present invention.

FIG. 17 shows perspective views of a clip according to an embodiment of the present invention.

FIG. 18 shows perspective views of a clip according to an embodiment of the present invention.

FIG. 19 shows perspective views of a clip according to an embodiment of the present invention.

FIG. 20 shows perspective views of an elastic strap band with a rectangular clip on each end to be clipped to the back of a book according to an embodiment of the present invention.

FIG. 21 shows perspective views of a clip according to an embodiment of the present invention.

FIG. 22 shows perspective views of a book with a mirror according to an embodiment of the present invention.

### DETAILED DESCRIPTION OF THE FIGURES AND OF PREFERRED EMBODIMENTS

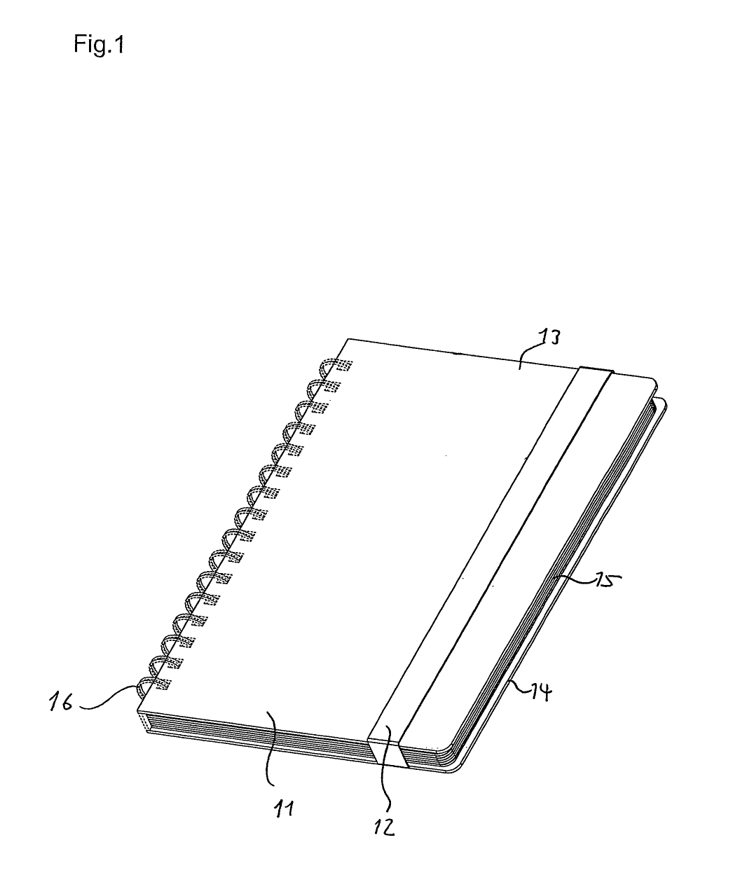

FIG. 1 shows a ring-bound book with an elastic strap band according to an embodiment of the present invention. The book (11) comprises a front cover (13), a back cover (14), and book pages (15) bound by the ring-binding (16) of the book. Furthermore, the book (11) comprises an elastic strap band (12) which is attached to the back cover (14). In FIG. 1, the book (11) is in a closed state and the elastic strap band (12) is wrapped around the front cover (13) for keeping the book (11) closed. In order to release the front cover (13) for opening the book (11), the elastic strap band (12) can be stretched further and pulled to the side, i.e. off of the front cover (13).

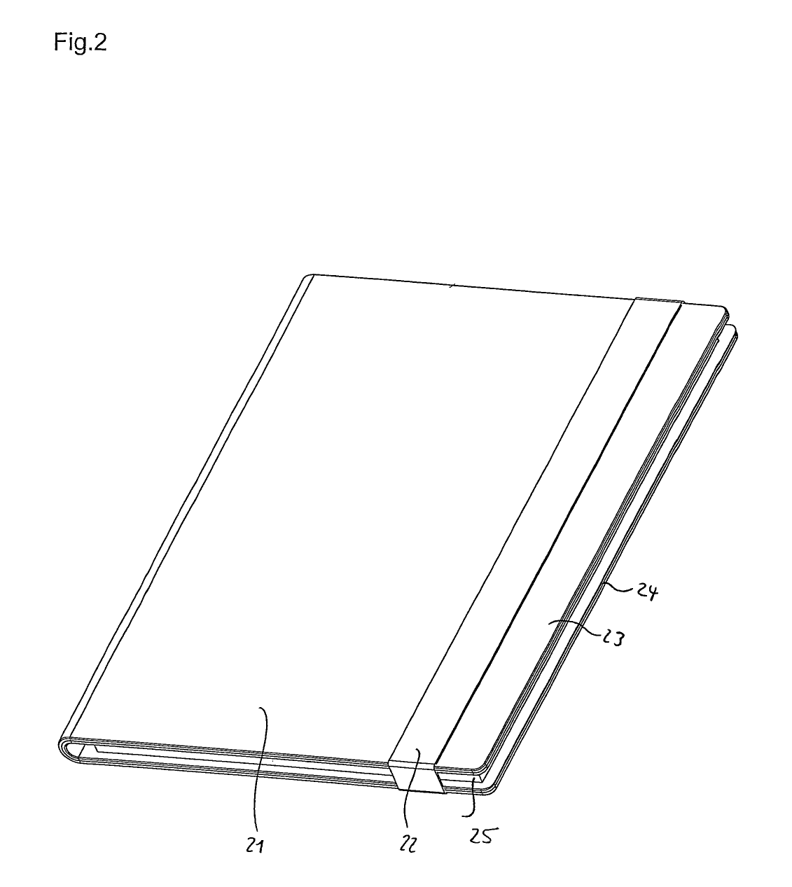

FIG. 2 shows a writing case with an elastic strap band according to an embodiment of the present invention. The writing case (21) comprises a front cover (23), a back cover (24), and pages (25) which respectively correspond to the front cover (13), back cover (14) and pages (15) described with reference to FIG. 1. Furthermore, the writing case (21) comprises an elastic strap band (22) corresponding to the elastic strap band (12) described with reference to FIG. 1 which is attached to the back cover (24). In FIG. 2, the writing case (21) is in a closed state and the elastic strap band (22) is wrapped around the front cover (23) for keeping the writing case (21) closed. In order to release the front cover (23) for opening the writing case (21), the elastic strap band (22) can be stretched further and pulled to the side, i.e. off of the front cover (23) which is the same principle as described with reference to FIG. 1.

Please note that the present invention in not limited to ring-bound books or writing cases and is not limited to attaching the elastic band strap on the back cover but can be used also for hard-bound books, adhesive-bound books, comb-bound books or any other object which comprises a front cover and a back cover wherein an elastic strap band can be attached to either the front cover, the back cover or any other part of the object and wrapped around the respective other cover or the covers in order to keep the book closed. Moreover it should be noted that although in FIGS. 1 and 2 the elastic band strap is wrapped around the covers parallel to the book spine/rings as one way to carry out the invention, the elastic band strap could also be wrapped around the covers in any other angle relative to the book spine/rings, e.g. perpendicular to the book spine/rings.

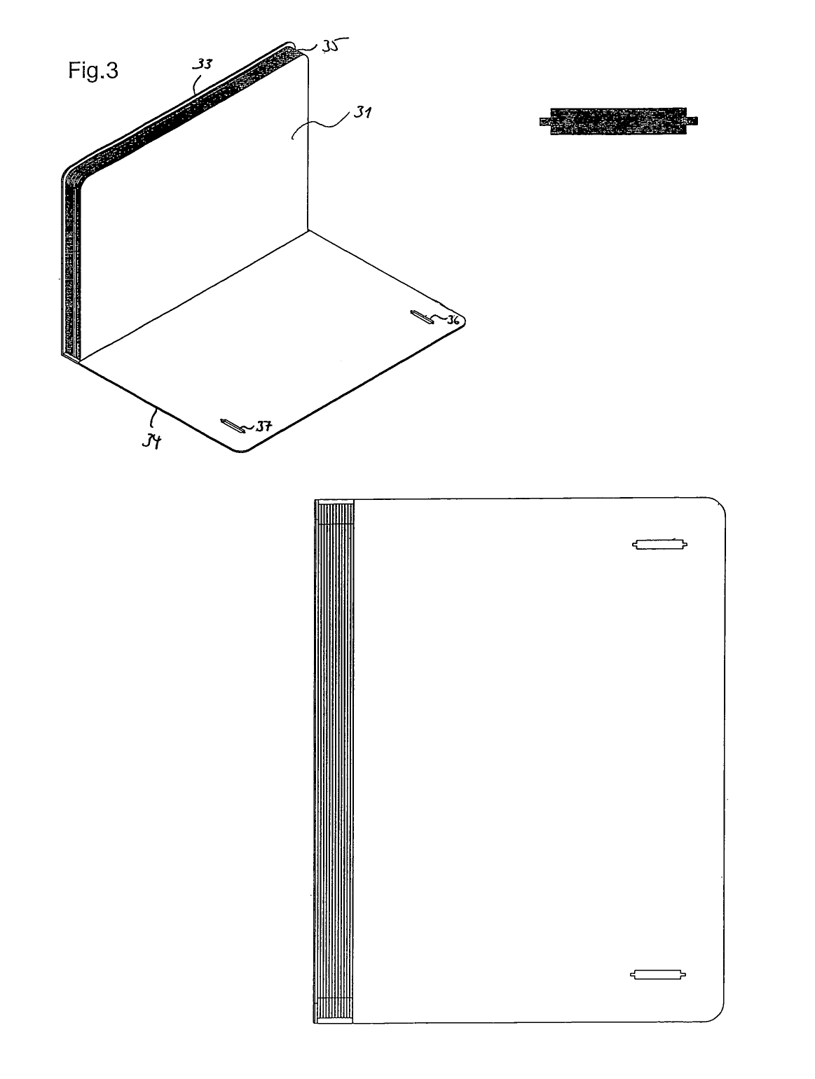

FIG. 3 shows perspective views of two slots on the back of a book according to an embodiment of the present invention. In FIG. 3, the book (31) comprises a front cover (33), a back cover (34), and book pages (35) between the front cover (33) and the back cover (34) and is shown in an opened state. Furthermore, the book (31) comprises two slots (36, 37) in the back cover (34) to receive clips to attach the elastic strap band to the back cover (34). The position of the slots (36, 37) in the back cover (34) depends on the aimed for angle between the binding direction of the book (31) and the elastic strap band (32). In FIG. 3 the binding direction of the book (31) and the aimed for orientation of the elastic strap band (32) are parallel.

Please note that the present invention in not limited to a parallel orientation of binding direction and elastic strap band but that any angle between binding direction and elastic strap band is possible, e.g. the elastic strap band may be oriented parallel to the bottom or top edge of the front or back cover.

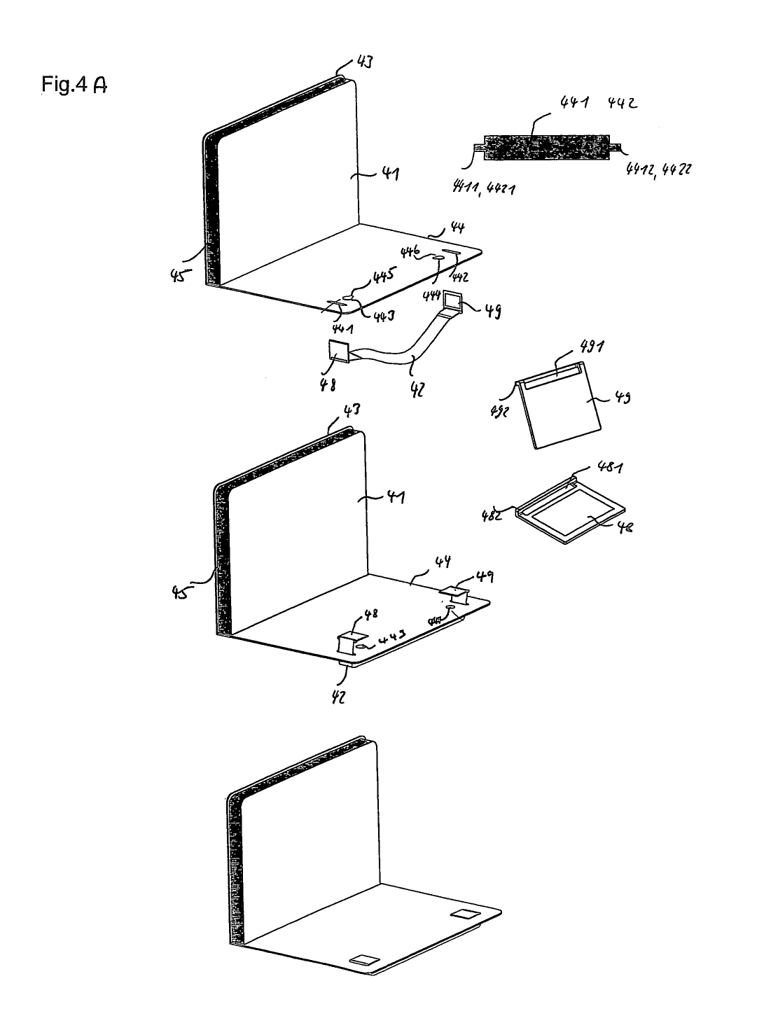

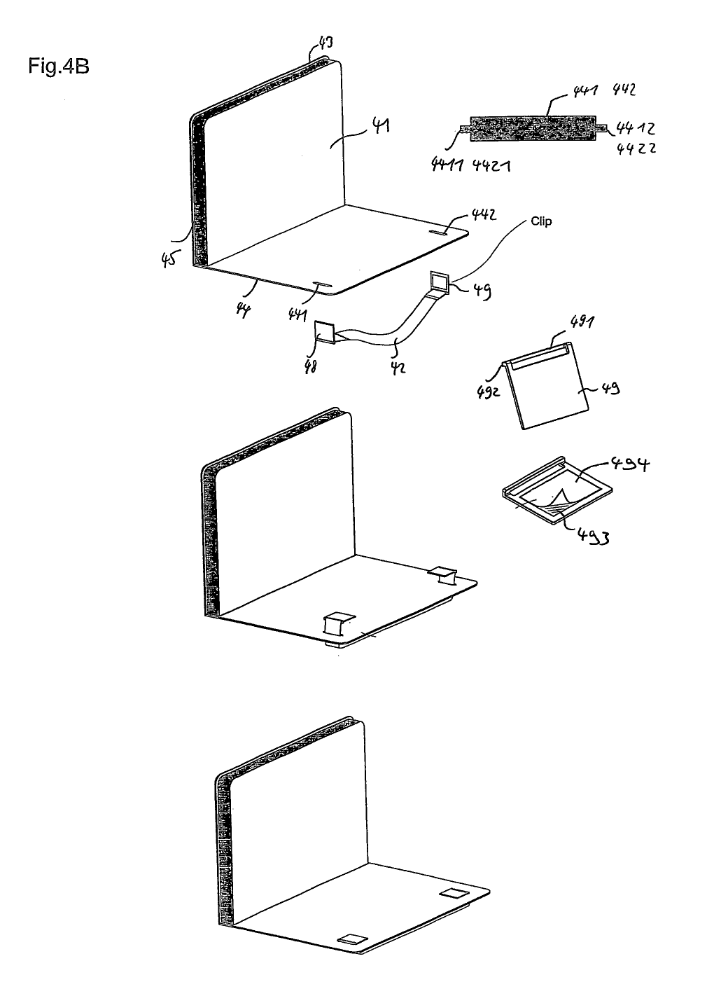

FIG. 4A shows perspective views of an elastic strap band with a rectangular clip on each end to be clipped to the back of a book according to an embodiment of the present invention. As in the foregoing embodiments, the book (41) comprises a front cover (43), a back cover (44), and book pages (45) between the front cover (43) and the back cover (44). The back cover (44) comprises two slots (441, 442) and two glue dots (443, 444) where each glue dot (443, 444) may be covered by a film (445, 446). The films (445, 446) can be removed from the glue dots (443, 444). The shape of the slots (441, 442) may be rectangular and the slots may further comprise rectangular notches (4411, 4421, 4412, 4422) on two opposing sides.

FIG. 4A also shows an elastic strap band (42) with two rectangular clips (48, 49) on each end. The rectangular clips (48, 49) may each comprise an elongated opening (481, 491) which may be used to connect the rectangular clips (48, 49) with the elastic strap band (42) by pulling each end of the elastic strap band (42) through the respective elongated opening (481, 482) of the rectangular clips (48, 49) and attaching each end of the elastic strap band (42) to the elastic strap band (42) such that each side of the elastic strap band (42) forms a loop. Said attaching may be achieved, e.g. by bonding, sewing, or cramping. The rectangular clips (48, 49) may also have a not fully flat shape, but the side to which the elongated opening (481, 491) is closest may be curved such that a lug (482, 492) may be formed. In an embodiment the lugs (482, 492) may have the shape of a bar and each loop of the elastic strap band (42) may be closed around a respective bar.

The elastic strap band (42) may be attached to the back cover (44) by pulling the rectangular clips (48, 49) through the slots (441, 442) such that the rectangular clips (48, 49) pass through the opposing rectangular notches (4411, 4421, 4412, 4422). The attachment may further be improved by bonding the rectangular clips (48, 49) to the back cover (44) of the book. The bonding may be achieved by removing the films (445, 446) from the glue dots (443, 444) and pressing the rectangular clips (48, 49) onto the glue dots (443, 444) such that adhesive bonding occurs. The attachment of the elastic strap band (42) to the back cover (44) of the book (41) may also be supported by the not fully flat shape of the rectangular clips (48, 49) if the lugs (482, 492) fit into the slots (441, 442). By this, a movement of the rectangular clips (48, 49) parallel to the back cover (44) of the book (41) may be prevented.

If the elastic strap band (42) is attached to the back cover (44) of the book (41), the book (41) can be kept in a closed state by pulling the elastic strap band (42) over the front cover (43). When the book (41) is closed, the clip (48, 49) is kept in a position parallel to the back cover (44) by the pressure acting upon the clip (48, 49) through the at least one page (45) and the front cover (43) which are pressed against the back cover (44) by the elastic strap band (42) and can therefore not be pulled out of the slot (441, 442).

FIG. 4B shows an alternative bonding configuration. Therein, the clip (48, 49) may comprise a glue dot (493) and a film (494) which covers the glue dot (493). After pulling the clip (48, 49) through the slot (441, 442) the film (494) may be removed and the clip (48, 49) can be bonded to the back cover (44).

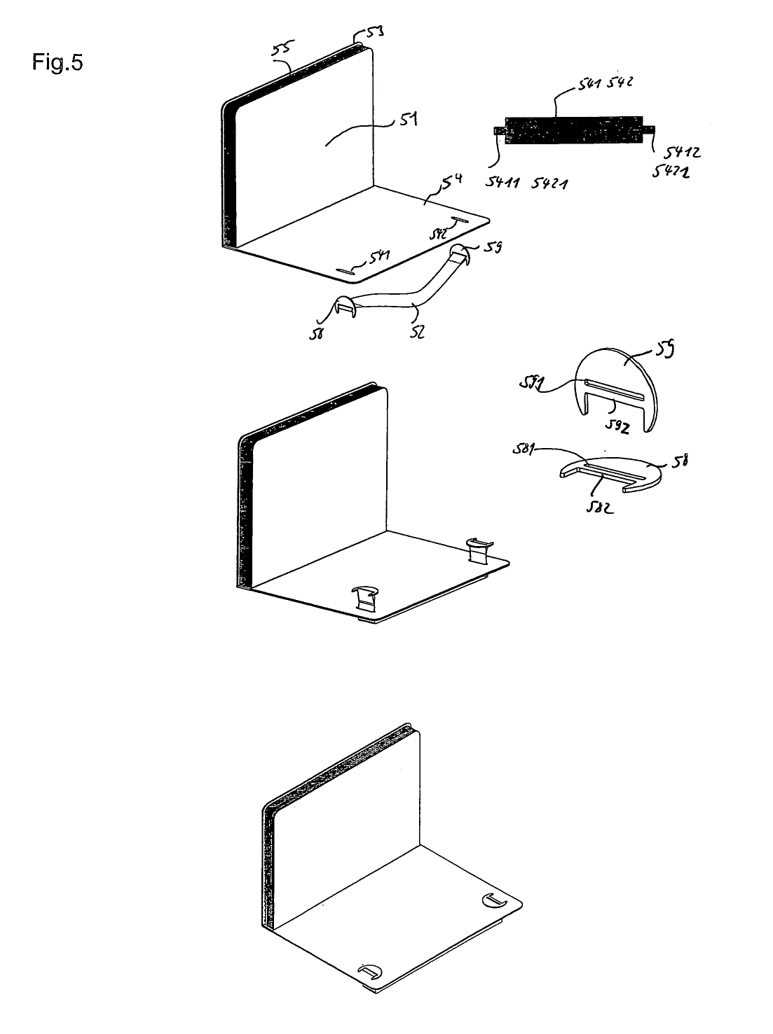

FIG. 5 shows perspective views of an elastic strap band with a crescent-shaped clip on each end to be clipped to the back of a book according to an embodiment of the present invention. As in the foregoing embodiments, the book (51) comprises a front cover (53), a back cover (54), and book pages (55) between the front cover (53) and the back cover (54). The back cover (54) comprises two slots (541, 542) and the shape of the slots (541, 542) may be rectangular and may comprise further rectangular notches (5411, 5421, 5412, 5422) on two opposing sides.

FIG. 5 also shows an elastic strap band (52). A crescent-shaped clip (58, 59) may be attached to each end of the elastic strap band (52). The crescent-shaped clips (58, 59) may each comprise an elongated opening (581, 591) which may be used to connect the crescent-shaped clips (58, 59) with the elastic strap band (52) by pulling each end of the elastic strap band (52) through the respective elongated opening (581, 591) of the crescent-shaped clips (58, 59) and attaching each end of the elastic strap band (52) to the elastic strap band (52) such that each side of the elastic strap band (52) forms a loop. A loop of the elastic strap band (52) may be closed around a bar (582, 592) between the elongated opening (581, 591) and a concave side of the crescent-shaped clip (58, 59).

The elastic strap band (52) may be attached to the back cover (54) by pulling the crescent-shaped clips (58, 59) through the slots (541, 542) such that the crescent-shaped clips (58, 59) pass through the opposing rectangular notches (5411, 5421, 5412, 5422). If the crescent-shaped clips (58, 59) are pulled through the slots (541, 542), the form of the crescent-shaped clips (58, 59) may prevent that the crescent-shaped clips (58, 59) are pulled back through the slots (541, 542). This is due to the fact that the crescent-shaped clips (58, 59) can only pass the slots when being held perpendicular to the back cover (54). However, the force acting on the crescent-shaped clips (58, 59) when pulling the respective side of the elastic strap band (52) acts against bringing the crescent-shaped clips (58, 59) in a position perpendicular to the back cover (54) if the bars (582, 592), over which the force is transmitted from the elastic strap band (52) to the crescent-shaped clips (58, 59), are arranged with distance to the convex hull of the respective crescent-shaped clip (58, 59), e.g. near the center.

If the elastic strap band (52) is attached to the back cover (54) of the book (51), the book (51) can be kept in a closed state by pulling the elastic strap band (52) over the front cover (52).

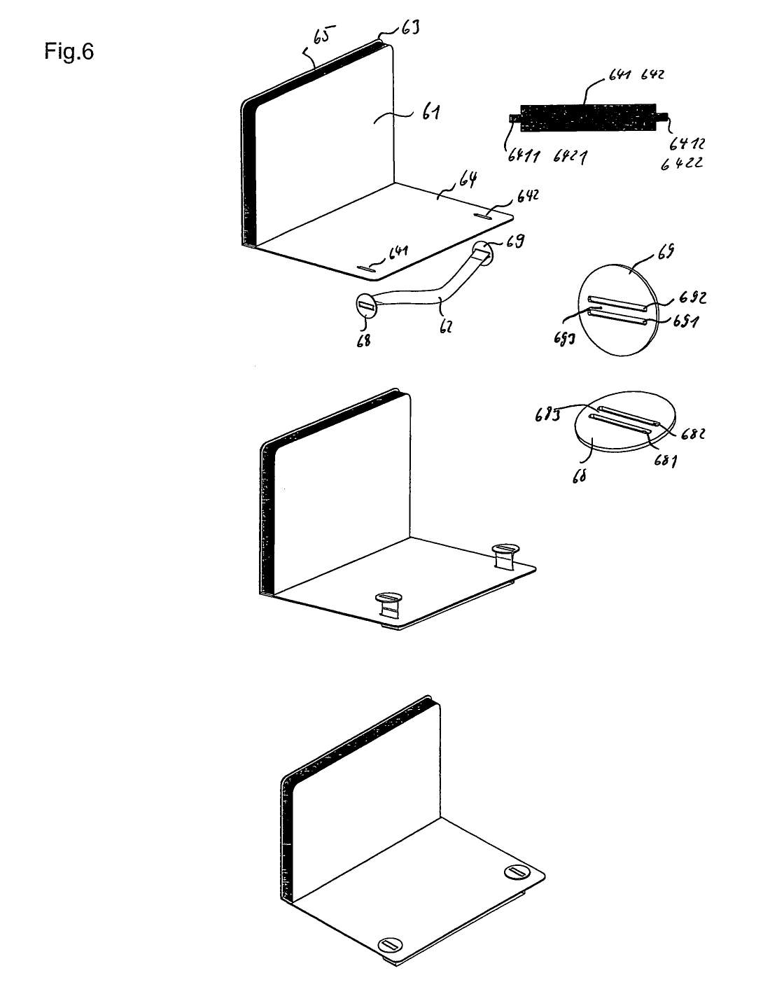

FIG. 6 shows perspective views of an elastic strap band with a round clip on each end to be clipped to the back of a book according to an embodiment of the present invention. As in the foregoing embodiments, the book (61) comprises a front cover (63), a back cover (64), and book pages (65) between the front cover (63) and the back cover (64). The back cover (64) comprises two slots (641, 642) and the shape of the slots (641, 642) may be rectangular and may comprise further rectangular notches (6411, 6421, 6412, 6422) on two opposing sides.

FIG. 6 also shows an elastic strap band (62). A round clip (68, 69) may be attached to each end of the elastic strap band (62). The round clips (68, 69) may each comprise two elongated openings (681, 682, 691, 692) which may be used to connect the round clips (68, 69) with the elastic strap band (62). This connection may be established by pulling each end of the elastic strap band (62) through one of the respective elongated openings (681, 682) or (691, 692) of the round clips (68, 69) and then through the remaining of the respective elongated openings in the other direction. The ends of the elastic strap band (62) may then be attached to the elastic strap band (62) such that each side of the elastic strap band (62) forms a loop. A loop of the elastic strap band (62) may be closed around a bars (683, 693) between the elongated openings (681, 682) or (691, 692) of the round clip (68, 69).

The elastic strap band (62) may be attached to the back cover (64) by pulling the round clips (68, 69) through the slots (641, 642) such that the round clips (68, 69) pass through the opposing rectangular notches (6411, 6421, 6412, 6422). If the round clips (68, 69) are pulled through the slots (641, 642), the form of the round clips (68, 69) may prevent that the round clips (68, 69) are pulled back through the slots (641, 642) in a manner similar to the one of the crescent-shaped clips (58, 59) described with reference to FIG. 5. Due to their shape, the round clips (68, 69) can only be pulled back when being held perpendicular to the back cover (64). However, the force acting on the round clips (68, 69) when pulling the respective side of the elastic strap band (62) acts against bringing the round clips (68, 69) in a position perpendicular to the back cover (64), if the bars (683, 693), over which the force is transmitted from the elastic strap band (62) to the crescent-shaped clips (68, 69), are not close to the edge of the respective round clip (68, 69).

If the elastic strap band (62) is attached to the back cover (64) of the book (61), the book (61) can be kept in a closed state by pulling the elastic strap band (62) over the front cover (62).

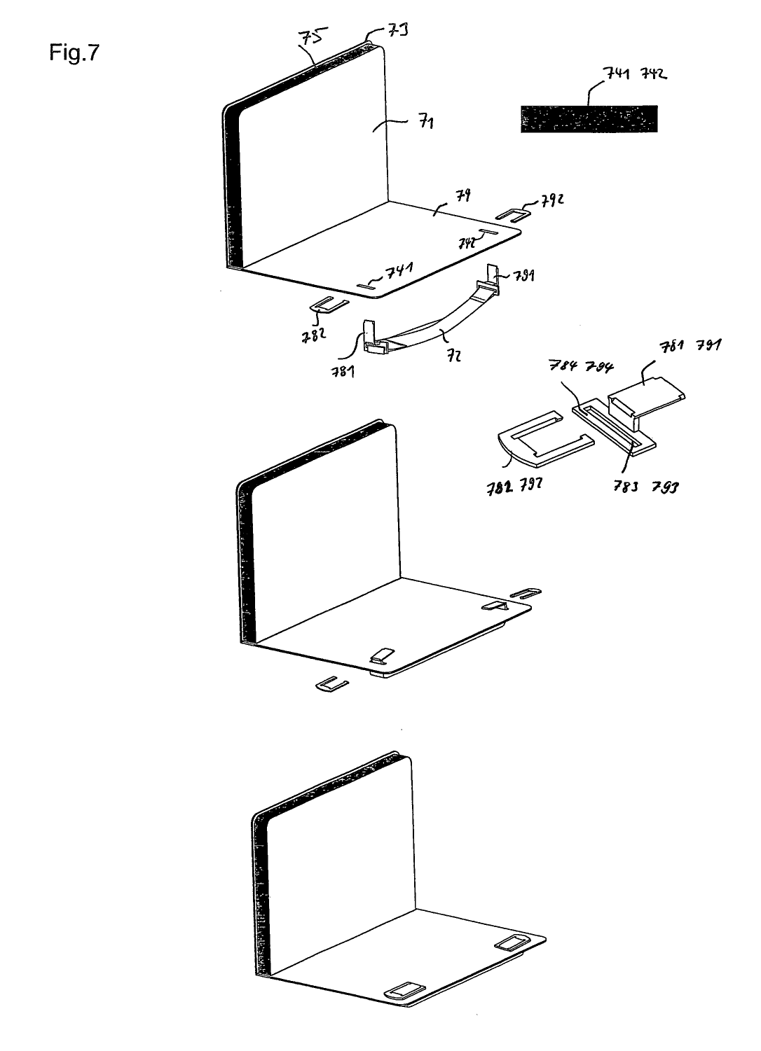

FIG. 7 shows perspective views of an elastic strap band with a rectangular clip on each end to be clipped to the back of a book using a clip shutter according to an embodiment of the present invention. As in the foregoing embodiments, the book (71) comprises a front cover (73), a back cover (74), and book pages (75) between the front cover (73) and the back cover (74). The back cover (74) comprises two slots (741, 742) and the shape of the slots (741, 742) may be rectangular.

FIG. 7 also shows an elastic strap band (72). A clip (781, 791) may be attached to each end of the elastic strap band (72).

The clip (781, 791) may comprise an elongated opening (783, 793) which may be used to connect the clip (781, 791) with the elastic strap band (72) by pulling an end of the elastic strap band (72) through the elongated opening (783, 793) of the clip (781, 791) and attaching the end of the elastic strap band (72) to the elastic strap band (72) such that a side of the elastic strap band (72) forms a loop. A loop of the elastic strap band (72) may be closed around a bar (784, 794) between the elongated opening (783, 793) and an edge of the clip (781, 791).

The elastic strap band (72) may be attached to the back cover (74) by pulling the clip (781, 791) through the slots (741, 742) and connecting a clamp (782, 792) to the clip (781, 791), the clamp (782, 792) thereby acting as a shutter. The connection of clip and clamp may be too big in shape to pass through the slots (741, 742) such that pulling the clips (781, 791) back is prevented. The clip (781, 791) consists of a first rectangular part which comprises the elongated opening. The first part is connected to a second part by rectangular connection. The second part is parallel to the first part but vertically displaced. The rectangular connection lies in a plane vertical to the planes of the first and second part. A part of an angle of an edge of the second part may be flattened from one direction and a part of an angle of the edge may be flattened from another direction in order to enable the connection between clip and clamp.

If the elastic strap band (72) is attached to the back cover (74) of the book (71), the book (71) can be kept in a closed state by pulling the elastic strap band (72) over the front cover (72).

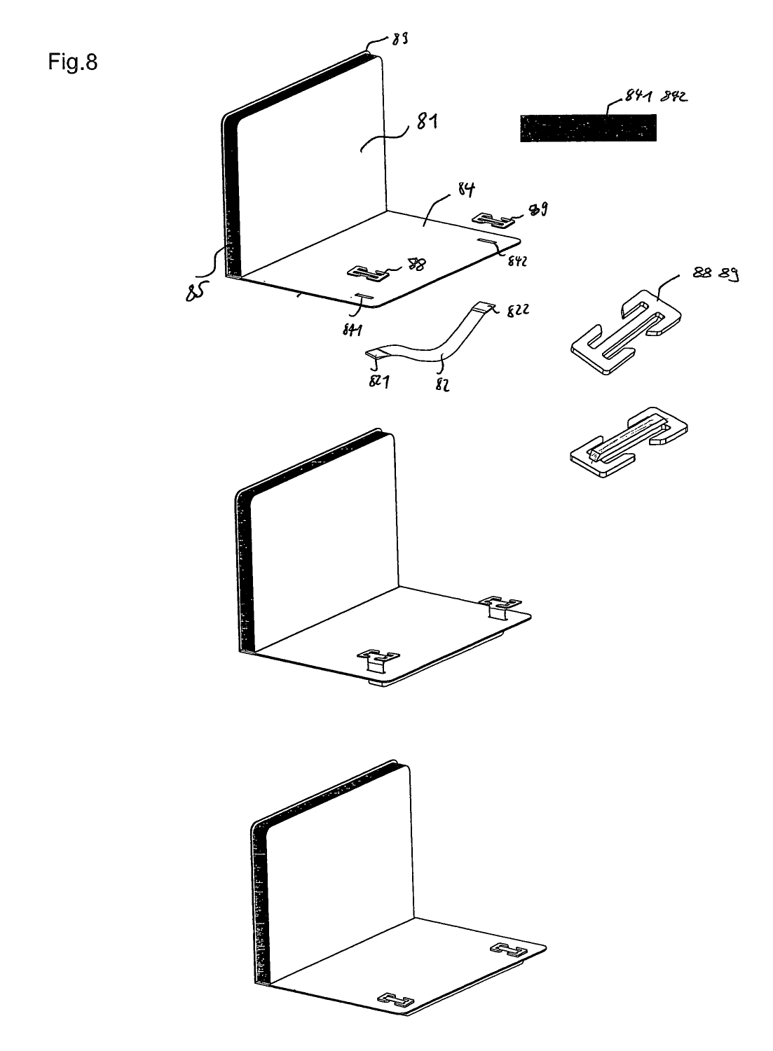

FIG. 8 shows perspective views of an elastic strap band with a rectangular clasp on each end to clip the elastic strap band to the back of a book according to an embodiment of the present invention. As in the foregoing embodiments, the book (81) comprises a front cover (83), a back cover (84), and book pages (85) between the front cover (83) and the back cover (84). The back cover (84) comprises two slots (841, 842) and the shape of the slots (841, 842) may be rectangular.

FIG. 8 also shows an elastic strap band (82) with a loop on each end.

The elastic strap band (82) may be attached to the back cover (84) by pulling the loops (821, 822) through the respective slots (841, 842) and strapping each loop over a shuttle-armature-shaped clasp (88, 89). Said strapping comprises stretching a loop (821, 822) of the elastic strap band (82) and pulling the shuttle-armature-shaped clasp (88, 89) through the loop (821, 822) and releasing the loop of the elastic strap band (82) when the first half of the shuttle-armature-shaped clasp (88, 89) has been pulled through the loop (821, 822). The loop (821, 822) is then closed around the central bar of the shuttle-armature-shaped clasp (88, 89). As the shuttle-armature-shaped clasp (88, 89) does not fit through the slots (841, 842), the elastic strap band (82) is safely attached to the back cover (84). The central bar of the clasp (88, 89) may be thicker than the rest of the clasp and may fit into the slot of a back which prevents that the clasp gets out of place.

If the elastic strap band (82) is attached to the back cover (84) of the book (81), the book (81) can be kept in a closed state by pulling the elastic strap band (82) over the front cover (82).

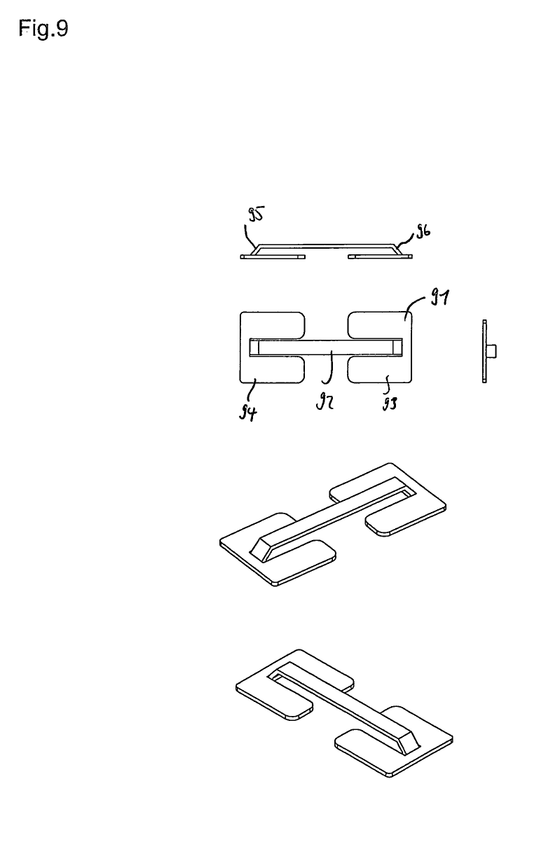

FIG. 9 shows perspective views of a clasp according to an embodiment of the present invention. The clasp (91) comprises a central bar (92) which connects two u-shaped elements (93, 94) to a shuttle-armature-shaped clasp. The central bar of the shuttle-armature-shaped clasp may not be in the same plane of the u-shaped elements (93, 94) but in a vertically displaced plane. The connection (95, 96) between the central bar (92) and the u-shaped elements (93, 94) does not extend perpendicular to the plane of the u-shaped elements (93, 94) but in an angle of 45 degrees. The central bar (92) of the clasp (91) may fit into the slot of a back cover as described with reference to FIG. 8 which prevents that the clasp gets out of place. Furthermore the fact that the central bar (92) is not in the same plane as the u-shaped elements (93, 94) may prevent that the elastic strap band closed around the central bar (92) extends beyond the plane of the u-shaped elements.

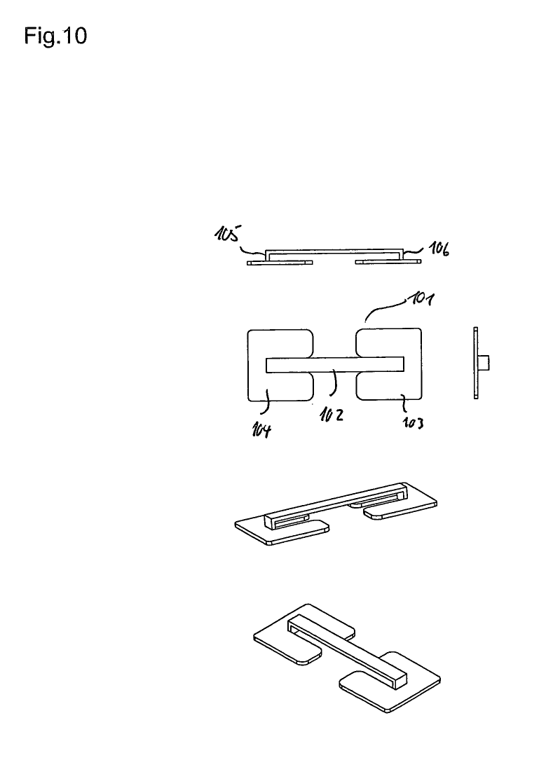

FIG. 10 shows perspective views of a clasp according to an embodiment of the present invention. The clasp (101) as shown in FIG. 10 corresponds to the clasp as described with reference to FIG. 9 in that it comprises two u-shaped elements (103, 104) which are connected by a central bar (102). However, the clasp (101) is different from clasp (91) in that the connection (105, 106) between the central bar (102) and the u-shaped elements (103, 104) does extend perpendicular to the plane of the u-shaped elements (103, 104) and not in an angle of 45 degrees.

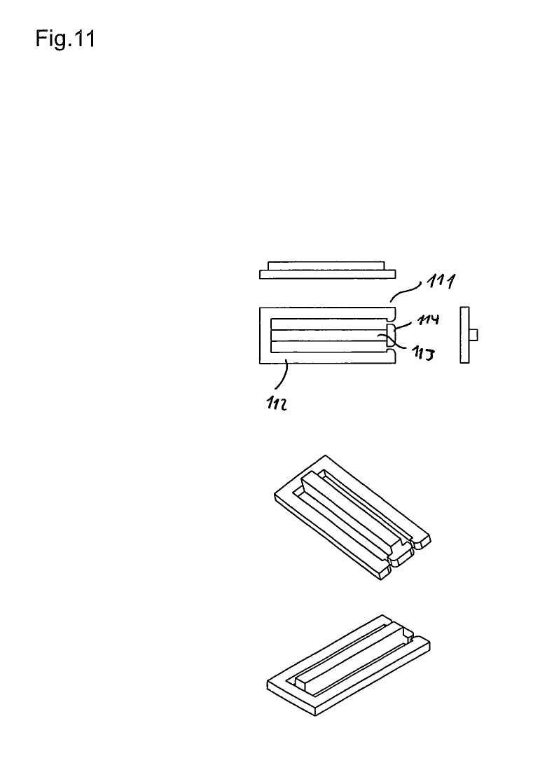

FIG. 11 shows perspective views of a clasp according to an embodiment of the present invention. The clasp (111) as shown in FIG. 11 comprises a u-shaped element (112) and a bar (113) where one end of the bar (113) is connected to the u-shaped element (112). The other end of the bar (114) which is not connected to the u-shaped element (112) has a protrusion or slab and is bigger than the other end, so that a loop of an elastic strap band which is tightly closed around the bar remains in position. The bar (114) may extend from the plane of the u-shaped element (112) such that the extension fits into a slot of a back cover as described with reference to FIG. 9, thereby preventing the clasp (111) to get out of place.

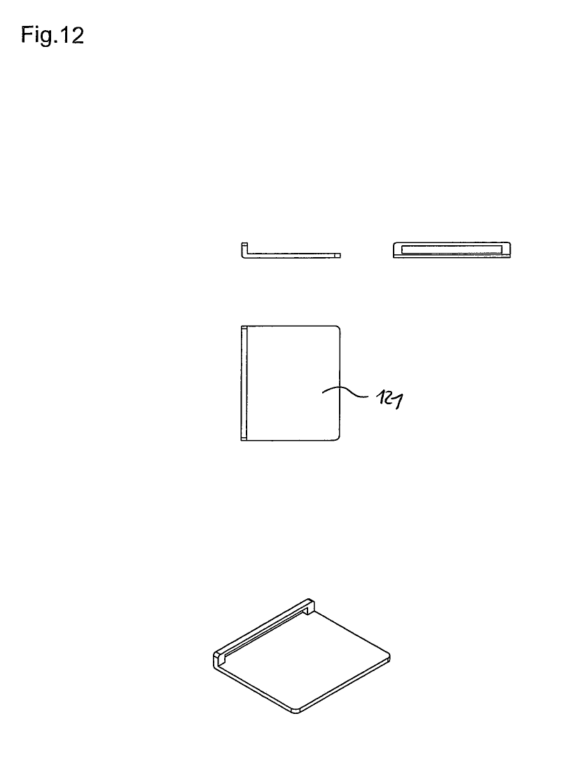

FIG. 12 shows perspective views of a clip according to an embodiment of the present invention. The clip (121) is similar to the clip (48, 49) as described with reference to FIG. 4A. However, the clip (121) does not have a fully rectangular shape but is rounded at the corners.

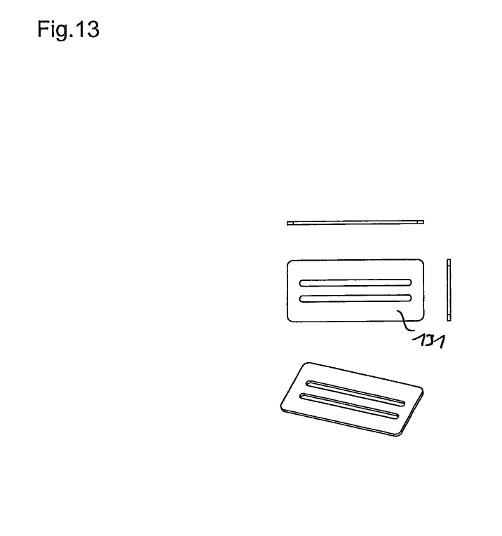

FIG. 13 shows perspective views of a clip according to an embodiment of the present invention. The clip (131) has a rectangular shape and comprises two elongated openings similar to the clip (68, 69) as described with reference to FIG. 6. Clip (131) may have a square shape and rounded corners.

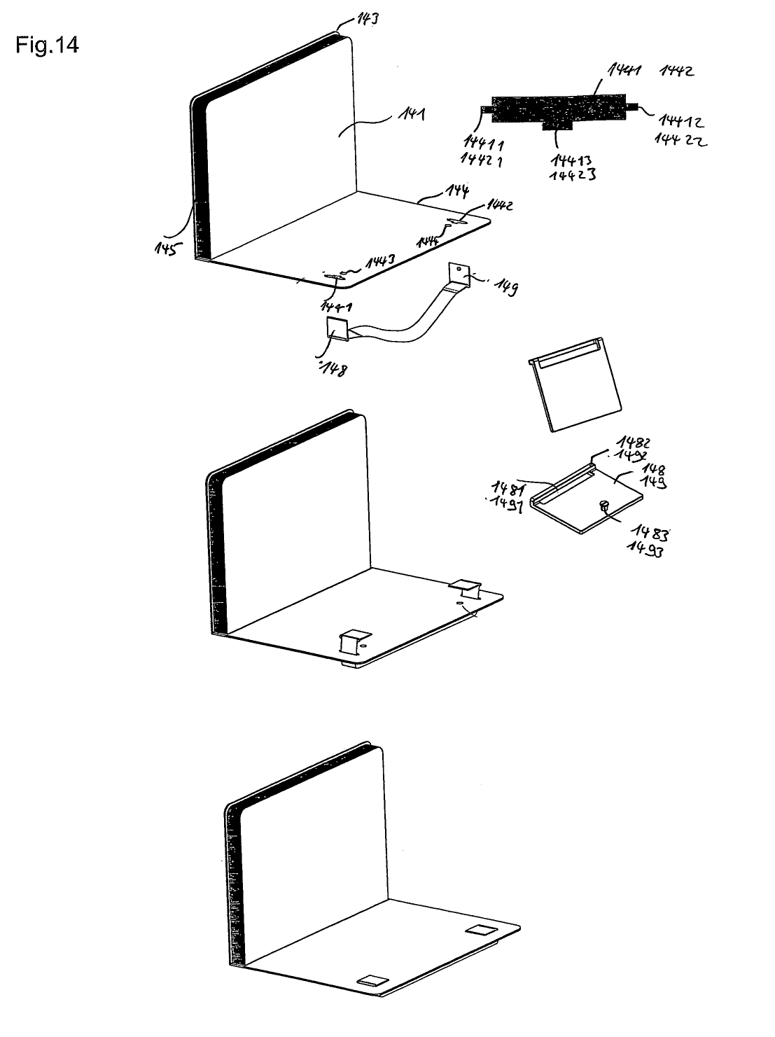

FIG. 14 shows perspective views of an elastic strap band with a rectangular clip with a pin on each end to be clipped to the back of a book according to an embodiment of the present invention. The book (141) comprises a front cover (143), a back cover (144), and book pages (145) between the front cover (143) and the back cover (144). The back cover (144) comprises two slots (1441, 1442) and two holes (1443, 1444). The shape of the slots (1441, 1442) may be rectangular and the slots may further comprise rectangular notches (14411, 14421, 14412, 14422) on two opposing sides. The shape of the holes may be round. Furthermore, each slot (1441, 1442) may comprise a further notch (14413, 14423) on a side other than the opposing notches. The shape of said further notch (14413, 14423) may be rectangular or round.

FIG. 14 also shows an elastic strap band (142) with two rectangular clips (148, 149) on each end. The rectangular clips (148, 149) may each comprise an elongated opening (1481, 1491) which may be used to connect the rectangular clips (148, 149) with the elastic strap band (142) by pulling each end of the elastic strap band (142) through the respective elongated opening (1481, 1482) of the rectangular clips (148, 149) and attaching each end of the elastic strap band (142) to the elastic strap band (142) such that each side of the elastic strap band (142) forms a loop. Said attaching may be achieved, e.g. by bonding, sewing, or cramping. The rectangular clips (148, 149) may also have a not fully flat shape, but the side to which the elongated opening (1481, 1491) is closest may be curved such that a lug (1482, 1492) may be formed. In an embodiment, the lugs (1482, 1492) may have the shape of a bar and each loop of the elastic strap band (142) may be closed around a respective bar. Furthermore, each clip (148, 149) may comprise a pin (1483, 1493).

The elastic strap band (142) may be attached to the back cover (144) by pulling the rectangular clips (148, 149) through the slots (1441, 1442) such that the rectangular clips (148, 149) pass through the opposing rectangular notches (14411, 14421, 14412, 14422) and the pin passes through the further notch (14413, 14423). The attachment may further be improved by pressing the pin (1483, 1493) through the hole (1443, 1444) in the back cover (144) of the book (141). The attachment of the elastic strap band (142) to the back cover (144) of the book (141) may also be supported by the angled shape of the rectangular clips (148, 149) if the lugs (1482, 1492) fit into the slots (1441, 1442). By this, a movement of the rectangular clips (148, 149) parallel to the back cover (144) of the book (141) may be prevented. A further advantage of said angled shape of the rectangular clips (148, 149) having perpendicular projecting lugs (1482, 1492) is that the elastic strap band (142) does not extend over the plane of the clips (148, 149) towards the pages (145).

If the elastic strap band (142) is attached to the back cover (144) of the book (141), the book (141) can be kept in a closed state by pulling the elastic strap band (142) over the front cover (143).

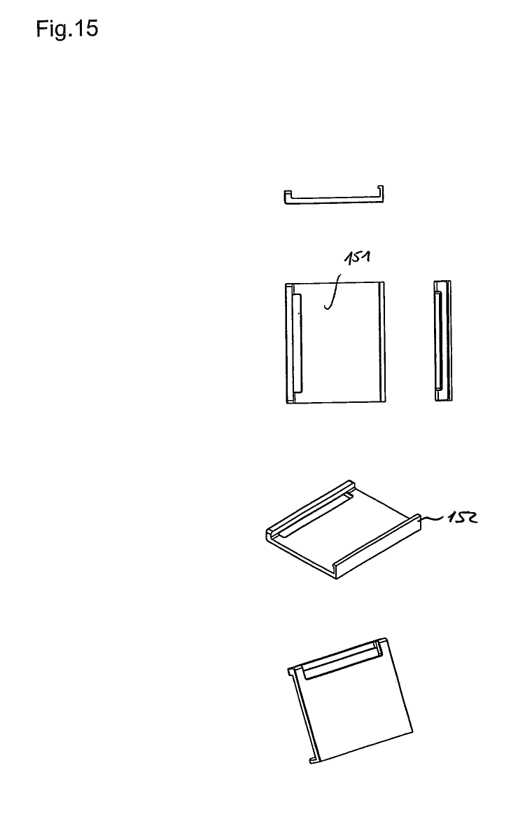

FIG. 15 shows perspective views of a clip according to an embodiment of the present invention. The clip (151) is similar to the clip (48, 49) as described with reference to FIG. 4A but further comprises another lug (152) on the opposite side of the lug as already described with reference to FIG. 4A. The another lug (152) extends in a direction towards the lug as described with reference to FIG. 4A. Said another lug (152) may be such that it extends over the edge of a back cover and acts as a hook which prevents the clip from being brought in a non-parallel position to the plane of the back cover once the clip has been clipped to the back cover. As an alternative, the another lug (152) may be such that not the whole clip is pulled through a slot of a back cover but only the another lug (152) is pulled through the slot of the back cover. In this case the another lug (152) may act as a hook which prevents the clip from being pulled back out of the slot of the back cover. A further alternative may be based on a configuration as described with reference to FIG. 4A where two additional slots are provided in the back cover (44) of the book (41). The another lug (152) may then be pressed into an additional slot where the shape of the another lug (152) acts like a hook and prevents that the clip (151) can be shifted and brought into an upright position.

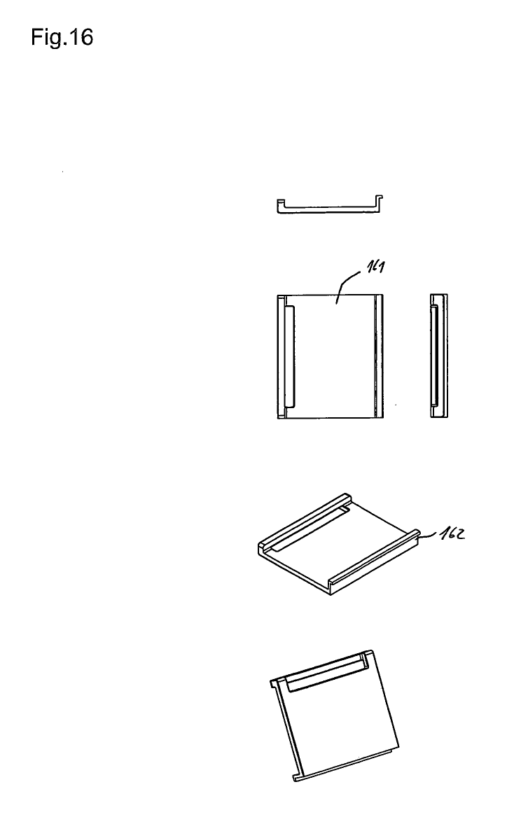

FIG. 16 shows perspective views of a clip according to an embodiment of the present invention. The clip (161) is similar to the clip (48, 49) as described with reference to FIG. 4A but further comprises another lug (162) on the opposite side of the lug as already described with reference to FIG. 4A. Said another lug (162) may be such that not the whole clip is pulled through a slot of a back cover but only the another lug (162) is pulled through the slot of the back cover. In this case the another lug (162) may act as a hook which prevents the clip from being pulled back out of the slot of the back cover. The difference between the another lug (162) and the another lug (152) as described with reference to FIG. 15 is that the another lug (162) extends not only perpendicular to the plane of the clip but also in a direction away from the lug as described with reference to FIG. 4A. As an alternative, a configuration similar to the further alternative described with reference to FIG. 15 may be provided where the back cover (44) of the book (41) comprises two additional slots and the another lug (162) may then be pressed into an additional slot where the shape of the another lug (162) acts like a hook and prevents the clip (161) from being brought into position perpendicular to the back cover.

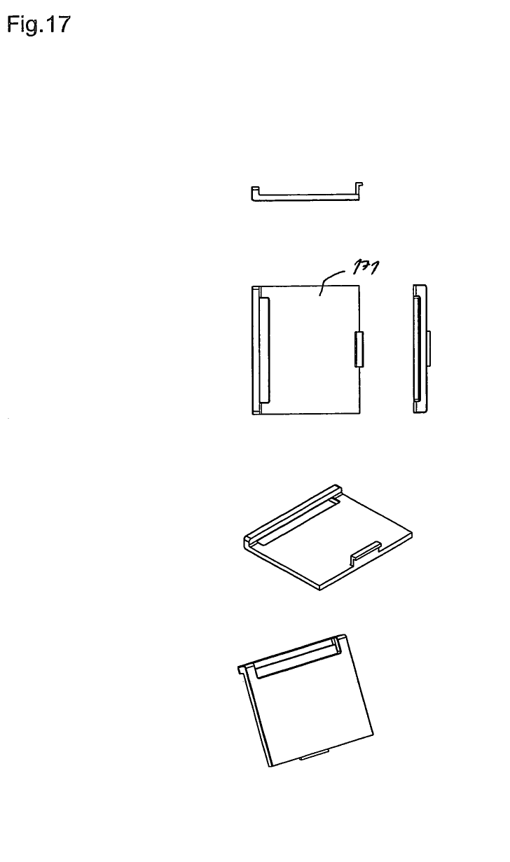

FIG. 17 shows perspective views of a clip according to an embodiment of the present invention. The clip (171) is similar to the clip as described with reference to FIG. 16 but differs from the clip (161) in that the another lug is not continued over the whole edge of the clip but only extends over a part of the edge. The clip may be attached to a back cover of a book using the same principles as described with reference to FIG. 16

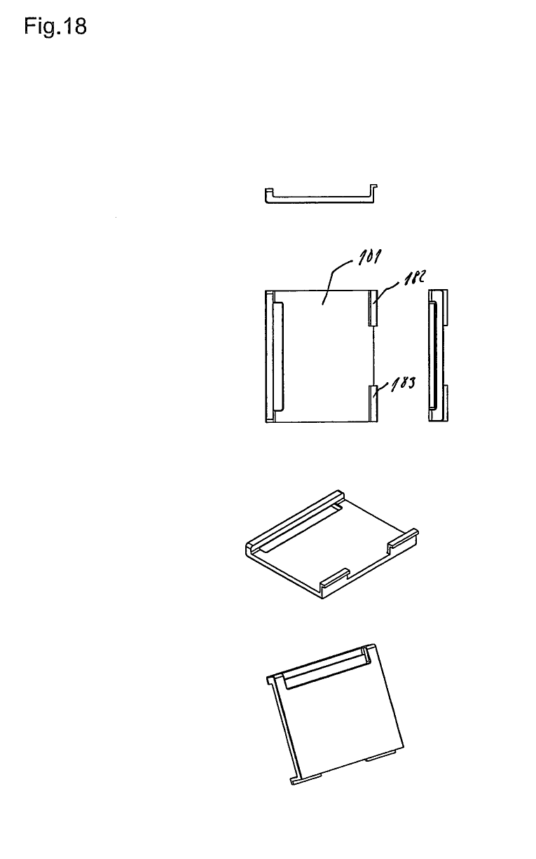

FIG. 18 shows perspective views of a clip according to an embodiment of the present invention. The clip (181) is similar to the clip as described with reference to FIG. 16 but differs from the clip (161) in that the another lug is not continued over the whole edge of the clip but broken in the middle of the edge so that two lugs (182, 183) exist. The clip may be attached to a back cover of a book using the same procedures as described with reference to FIG. 16.

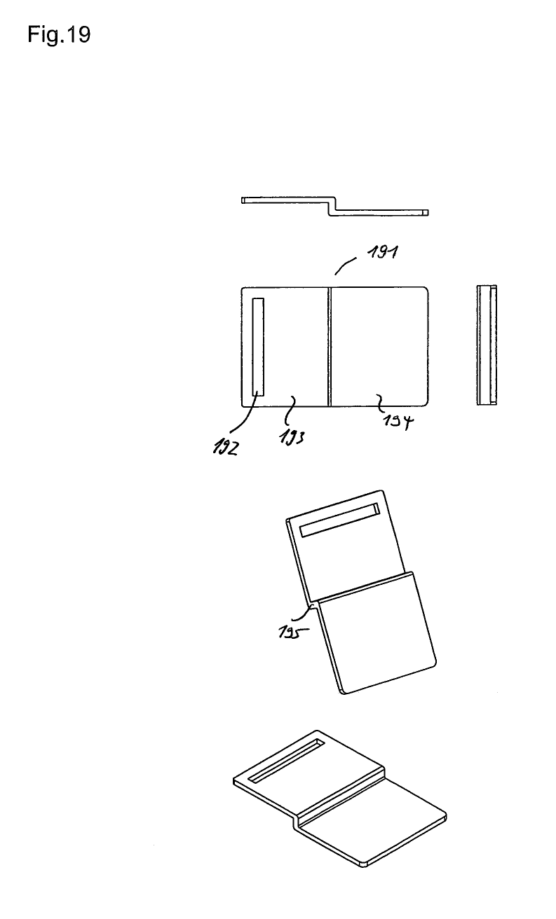

FIG. 19 shows perspective views of a clip according to an embodiment of the present invention. The clip (191) comprises an elongated opening (192) in a rectangular part (193) of the clip which is parallel to a first plane. The first part (193) of the clip (191) is connected to a second rectangular part (194) which is parallel to a second plane where the second plane and the first plane are parallel and displaced in perpendicular direction by a third part (195) which lies in a plane perpendicular to the first and second plane. Such a clip with a step-like shape may be used to connect an elastic strap band to a back cover of a book by pulling the elastic strap band through the elongated opening (192) and connecting the end of the elastic strap band to the elastic strap band such that one side of the elastic strap band forms a loop which is closed around a bar between the elongated opening (192) and an edge of the first part (193) of the clip (191). The elastic strap band may then be attached to the back cover by pulling the second part (194) through a slot of the back cover. The form of the clip then prevents that the clip is pulled back through the slot when the clip lies flat on the back cover and force acting on the clip pulls the clip in a direction parallel to the plane of the back cover.

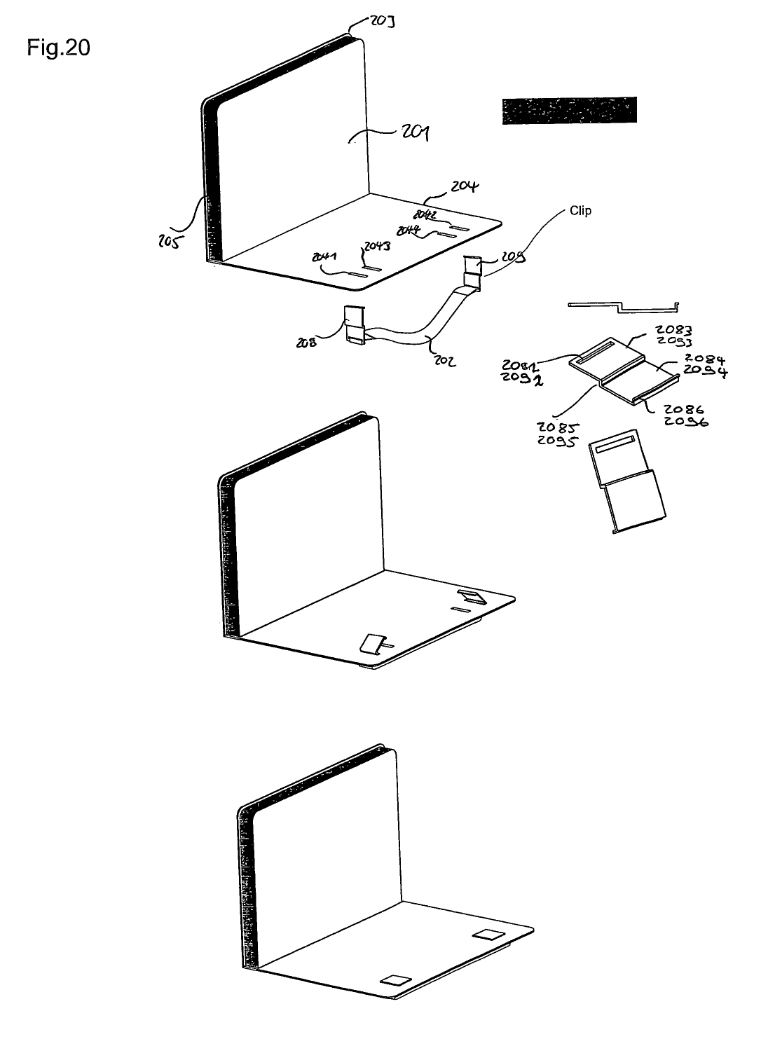

FIG. 20 shows perspective views of an elastic strap band with a rectangular clip on each end to be clipped to the back of a book according to an embodiment of the present invention. As in some of the foregoing embodiments, the book (201) comprises a front cover (203), a back cover (204), and book pages (205) between the front cover (203) and the back cover (204). The back cover (204) comprises four slots (2041, 2042, 2043, 2044). The shape of the slots (2041, 2042, 2043, 2044) may be rectangular.

FIG. 20 also shows an elastic strap band (202) with two rectangular clips (208, 209) on each end. Each of the clips (208, 209) is similar to the clip (191) as described with reference to FIG. 19 but further comprises another lug (2086, 2096) on a edge of a second part of the clip (2084) opposing the connection (2085, 2095) between first (2083) and second (2084) part which extends from the second part (2084, 2085) in an direction parallel to the connection between second (2084, 2094) and first part (2083, 2093). Furthermore, the rectangular clips (208, 209) may each comprise an elongated opening (2082, 2092) which may be used to connect the rectangular clips (208, 209) with the elastic strap band (202) by pulling each end of the elastic strap band (202) through the respective elongated opening (2082, 2092) of the rectangular clips (208, 209) and attaching each end of the elastic strap band (202) to the elastic strap band (202) such that each side of the elastic strap band (202) forms a loop. Said attaching may be achieved, e.g. by bonding, sewing, or cramping.

The elastic strap band (202) may be attached to the back cover (204) by pulling the second part (2084, 2094) of the rectangular clips (208, 209) through the slots (2041, 2042). The attachment may further be improved by the not fully flat shape of the second part (2084, 2094) of the rectangular clips (208, 209) if the lugs (2086, 2096) fit into the slots (2043, 2044). By this, a movement of the rectangular clips (208, 209) parallel to the back cover (204) of the book (201) may be prevented.

If the elastic strap band (202) is attached to the back cover (204) of the book (201), the book (201) can be kept in a closed state by pulling the elastic strap band (202) over the front cover (203).

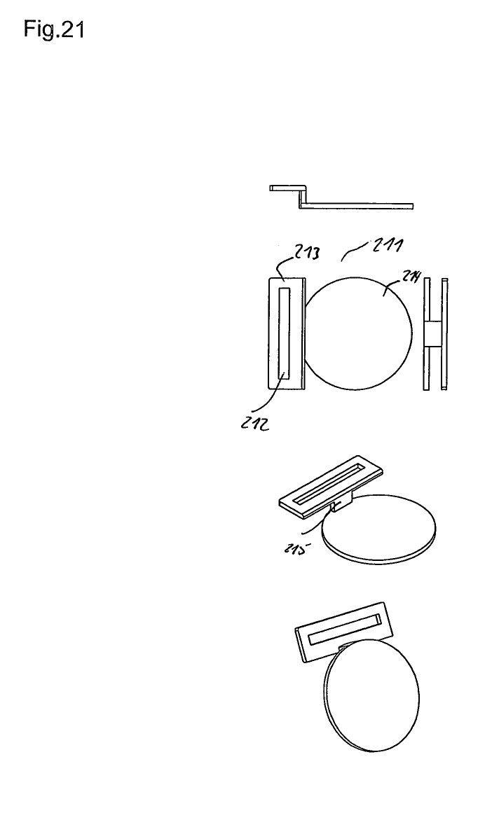

FIG. 21 shows perspective views of a clip according to an embodiment of the present invention. The clip (211) comprises an elongated opening (212) in a rectangular part (213) of the clip which is parallel to a first plane. The first part (213) of the clip (211) is connected to a second round part (214) which is parallel to a second plane where the second plane and the first plane are parallel and displaced in perpendicular direction by a third part (215) which lies in a plane perpendicular to the first and second plane. Such a clip may be used to connect an elastic strap band to a back cover of a book by pulling the elastic strap band through the elongated opening (212) and connecting the end of the elastic strap band to the elastic strap band such that one side of the elastic strap band forms a loop which is closed around a bar between the elongated opening (212) and an edge of the first part (213) of the clip (211). The elastic strap band may then be attached to the back cover by pulling the second part (214) through a slot of the back cover. The form of the clip then prevents that the clip is pulled back through the slot when the clip lies flat on the back cover and force acting on the clip pulls the clip in a direction parallel to the plane of the back cover.

Although the possibility to glue a clip to a cover has only been described with reference to FIG. 4A, it should clear that such gluing can be applied to all clips as described in the foregoing embodiments.

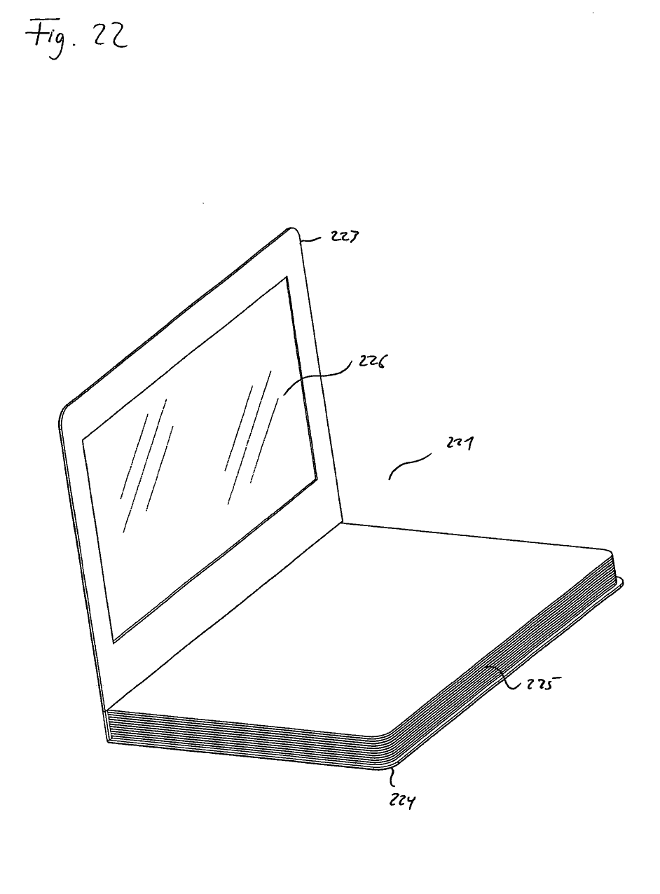

FIG. 22 shows perspective views of a book with a mirror according to an embodiment of the present invention. The book (221) comprises a front cover (223), a back cover (224), and book pages (225). Furthermore, the book (221) comprises an elastic strap band which is attached to the back cover (224). In FIG. 22, the book (221) is in an opened state and the front cover (223) may comprise a mirror (226). As an alternative, the mirror (226) may be attached to the back cover (224). It should be clear that such a mirror may a feature of any of the forgoing embodiments.

Please note that although the embodiments herein have been described with reference to two identical clips it should be clear that any combination of clip and/or clamp shapes as described herein is possible. Moreover, it is also possible to use only one clip and to attach the two loops of the elastic strap band to the same bar. Furthermore, it is clear that the shape of a clip can be modified in any possible way as long as the clip comprises a bar around which a loop of an elastic strap band can be closed and means to prevent the elastic strap band to slip from the bar.

Features, components and specific details of the structures of the above-described embodiments may be exchanged or combined to form further embodiments of the present invention optimized for the respective application. As far as those modifications are readily apparent for an expert skilled in the art they shall be disclosed implicitly by the above description without specifying explicitly every possible combination, for the sake of conciseness of the present description.

1. A stationary object comprising:
a first cover,
a second cover comprising a slot,
at least one page between the first and second cover, and
an elastic strap band attachable to the second cover, the elastic strap band being configured to be wrapped around the first cover for keeping the covers closed around the at least one page,
wherein the elastic strap band is a flat elastic strap band and is attached to the second cover with a clip, an end of the flat elastic strap band forming a loop around a bar of the clip for attaching the clip to the flat elastic strap band.

2. The stationary object according to claim 1, wherein the clip comprises at least one elongated opening and is attached to the flat elastic strap band by pulling an end of the flat elastic strap band through the at least one elongated opening of the clip and attaching the end to the flat elastic strap band, the flat elastic strap band thereby forming the loop.

3. The stationary object according to claim 1, wherein the slot is rectangular.

4. The stationary object according to claim 3, wherein the rectangular slot has two opposing notches.

5. The stationary object according to claim 1, wherein the flat elastic strap band is attachable to the second cover by pulling the clip through the slot.

6. The stationary object according to claim 1, wherein the clip is a rectangular clip with a bar shaped lug on one side which extends from a plain of said clip in a perpendicular direction and the loop of the flat elastic strap band is closed around said lug.

7. The stationary object according to claim 1, wherein the clip is a crescent-shaped clip with an elongated opening and the loop of the flat elastic strap band is closed around a bar between the elongated opening and a concave side of the crescent-shaped clip.

8. The stationary object according to claim 1, wherein the clip is a round or rectangular clip with two elongated openings and the loop of the flat elastic strap band is closed around a bar between the elongated openings of the clip.

9. The stationary object according to claim 1, wherein the clip comprises an elongated opening and the loop of the elastic strap band is closed around a bar between the elongated opening and an edge of the clip, and
a clamp is provided, the clamp being connectable to the clip so that the connection of the clip and the clamp cannot be pulled back through the slot.

10. The stationary object according to claim 1, wherein the clip has the shape of a shuttle-armature-shaped clasp and the loop of the flat elastic strap band is closed around a central bar of said clasp.

11. The stationary object according to claim 1, wherein the stationary object is a hard-bound book, an adhesive-bound book, a comb-bound book or a ring-bound book.

12. The stationary object according to claim 1, wherein the stationary object is a notebook, a calendar, a Filofax or a writing pad.

13. The stationary object according claim 1, wherein the clip is glued to the second cover.

14. A stationary object comprising:
a first cover,
a second cover,
at least one page between the first and second cover, and
an elastic strap band attachable to the second cover, the elastic strap band being configured to be wrapped around the first cover for keeping the covers closed around the at least one page,
wherein at least one of the first and second covers comprises a mirror.

15. A method for attaching an elastic strap band on a cover of a stationary object comprising a first cover, a second cover, and at least one page, the method comprising the steps of:
connecting a clip to the elastic strap band,
providing a slot in the second cover, and
pulling the clip through the slot of the second cover,
wherein the elastic strap band is a flat elastic strap band and an end of the flat elastic strap band forms a loop around a bar of the clip for connecting the clip to the flat elastic strap band.

16. The stationary object according to claim 1, wherein at least one of the first or second covers includes a mirror.
